(19) United States
(12) Patent Application Publication
(10) Pub. No.: US 2008/0228574 A1
(43) Pub. Date: Sep. 18, 2008

(54) System And Method For Conveying Content Changes Over A Network

(75) Inventors: Jeffrey A. Stewart, New York, NY (US); Shera Ahmad, Rego Park, NY (US)

Correspondence Address: FISH & RICHARDSON P.C., P.O. BOX 1022, MINNEAPOLIS, MN, 55440-1022, US

(73) Assignee: Monitor110, Inc., New York, NY (US)

(21) Appl. No.: 11/870,859

(22) Filed: Oct. 11, 2007

Related U.S. Application Data
(60) Provisional application No. 60/850,637, filed on Oct. 11, 2006.
(60) Provisional application No. 60/850,638, filed on Oct. 11, 2006.
(60) Provisional application No. 60/892,945, filed on Mar. 5, 2007.

(51) Int. Cl. G06Q 30/00

(52) U.S. Cl. 705/14; 705/1

(57) ABSTRACT

A system and method that includes receiving data representative of a change in volume of network content related to a ticker from a reference volume; and displaying in a user interface a visual element associated with the ticker, wherein the appearance of the visual element depends upon the change in volume.

### CLAIM OF PRIORITY

This application claims the benefit of priority to U.S. Provisional Application No. 60/850,637, filed Oct. 11, 2006, U.S. Provisional Application No. 60/850,638, filed Oct. 11, 2006, and to U.S. Provisional Application No. 60/892,945, filed Mar. 5, 2007, all of which are incorporated herein by reference in their entirety.

### TECHNICAL FIELD

The present invention generally relates to systems and methods for displaying information related to content and content changes over a network, such as the Internet.

### BACKGROUND

Financial and business intelligence analysts desire current and updated information from multiple sources in order to, for example, recommend the purchase or sale of financial products, perform trend analysis, and identify opportunities within the marketplace. Similarly, businesses often track the performance and events associated with their competitors. Individuals performing such analysis desire information trends to be displayed in real time or close to real time and in a manner that provides the status of updated information efficiently. By way of example, financial information associated with a stock price for a specific company or fund is typically displayed on a graphic user interface listing multiple financial ticker symbols or company names in a column. Current and updated information about the share price, highest sale, lowest sale, last sale, averages and other statistics is displayed in a column adjacent to the company name or financial ticker symbol. Analysts and other financial services professionals are accustomed to information displayed in this manner.

The financial services industry, however, looks to many sources beyond pure market data to support decisions. Meaningful and actionable information is often posted to the Internet by one or more individuals before it is available on traditional information sources such as news wire services or cable news networks. Other individuals may follow up with postings or Internet discussions of their own, thus generating more content. For example, problems with a new product or a delayed launch date are often discussed in Internet chat rooms and blogs before such information is disseminated by a news wire service. Identifying and quantifying new or updated content in large data sets would be significant to an analyst because often the most interesting piece of information is the new information.

To date, Internet search engines provide a tool for searching web pages and other Internet content for information. Such search engines, however, do not typically provide user-friendly statistics about new or updated content related to a particular topic of interest in a useable manner and in an interface familiar to an analyst. It has been found that analysts and financial services professionals would benefit from the display of information relating to content changes on the Internet, and particularly if such display is a familiar interface.

The discussion of the background to the invention herein is included to explain the context of the invention. This is not to be taken as an admission that any of the material referred to was published, known, or part of the common general knowledge as at the priority date of any of the claims.

Throughout the description and claims of the specification the word “comprise” and variations thereof, such as “comprising” and “comprises”, is not intended to exclude other additives, components, integers or steps.

### SUMMARY

The present invention addresses a system and method for providing new or updated content and content statistics related to a particular topic of interest in a useable manner and in an interface familiar to an analyst.

The present invention provides a method that includes receiving data representative of a change in volume of network content related to a ticker from a reference volume and displaying in a user interface a visual element associated with the ticker, wherein the appearance of the visual element depends upon the change in volume. The visual element may include one or more characters representing the ticker. The one or more characters may be displayed in a first color if the change in volume is less than a threshold volume. Alternatively, the one or more characters may be displayed in a second color if the change in volume is an increase greater than or equal to the threshold volume. Still alternatively, the one or more characters may be displayed in a third color if the change in volume is a decrease greater than or equal to the threshold volume. For example, the second color may be green and the third color may be red.

Furthermore, the visual element may include a first symbol displayed in the vicinity of the one or more characters if the change in volume is an increase greater than or equal to twice the threshold volume; and a second symbol displayed in the vicinity of the one or more characters if the change in volume is a decrease greater than or equal to twice the threshold volume. The visual element may also include an additional first symbol displayed in the vicinity of the one or more characters if the change in volume is an increase greater than or equal to three times the threshold volume; and an additional second symbol displayed in the vicinity of the one or more characters if the change in volume is a decrease greater than or equal to three times the threshold volume.

In an implementation, the method provided in the present invention may include a first symbol displayed in the vicinity of the one or more characters if the change in volume is an increase greater than or equal to a threshold volume; and a second symbol displayed in the vicinity of the one or more characters if the change in volume is a decrease greater than or equal to the threshold volume. In this implementation, the visual element may include an additional first symbol displayed in the vicinity of the one or more characters if the change in volume is an increase greater than or equal to two times the threshold volume; and an additional second symbol displayed in the vicinity of the one or more characters if the change in volume is a decrease greater than or equal to two times the threshold volume.

In an implementation, the method provided in the current invention may include displaying an indicator in the vicinity of the visual element to indicate a source of network content that attributed to the change in volume. The visual element and the indicator may be distinguished from other aspects of the user interface if network content that attributed to the change in volume was detected within a predefined period of time. The visual element and indicator may be distinguished from other aspects of the user interface by encircling the visual element and the indicator. The indicator may be adapted to change in appearance as time passes from when the network content that attributed to the change in volume was first detected. For example, the indicator may blink intermittently; gradually fade away as time passes; and/or disappear after a period of time passes from when the network content that attributed to the change in volume was first detected.

The present invention further provides an apparatus that includes a processor; a display screen coupled to the processor; and memory coupled to the processor. The memory includes logic that has access to data representative of a change in volume of network content related to a ticker from a reference volume and that is operable when executed by the processor to display in a user interface on the display screen a visual element associated with the ticker, wherein the appearance of the visual element depends upon the change in volume.

### BRIEF DESCRIPTION OF THE DRAWINGS

FIG. 1 shows an exemplary system according to an implementation of the present invention;

FIG. 2 shows an exemplary system according to an implementation of the present invention;

FIG. 3 shows an exemplary system according to an implementation of the present invention;

FIG. 4 shows a flow-chart of an exemplary method of the present invention;

FIG. 5 shows an exemplary user interface according to an implementation of the present invention;

FIG. 6 shows an exemplary user interface according to an implementation of the present invention; and

FIGS. 7A-D show exemplary user interfaces according to an implementation of the present invention.

### DETAILED DESCRIPTION

The system and methods described herein are directed to a system and method for providing new or updated content and content statistics related to a particular topic of interest in a useable manner and in an interface familiar to an analyst. As used herein, examples of topics of interest include a particular company, an industry sector, a common area of interest, or a common theme.

In one implementation, content, in the form of RSS feeds or raw HTML information, is pulled from identified web sites on the World Wide Web, or other Internet sources. The content is evaluated to determine the credibility and trusted authoritativeness of the content. Changes to the content in the form of additions, deletions, or updates from the last posting are identified. The changes are filtered to remove predictable or irrelevant changes from the identified changes to the content. The content is categorized and indexed to evaluate and identify relevant terms, including but not limited to, a pre-determined list of financial terms or company specific terms, other company or individual names, etc. Information about the content is then displayed on a display and user interface in a manner in which information are viewable in summary form associated with, for example, a financial ticker.

In this manner individuals such as industry analysts, financial analysts, or other business intelligence professionals are able to efficiently identify and evaluate new or updated content and content statistics found on a webpage, blog posting, or other Internet source that is associated with a particular company, industry sector, common area of interest or common theme.

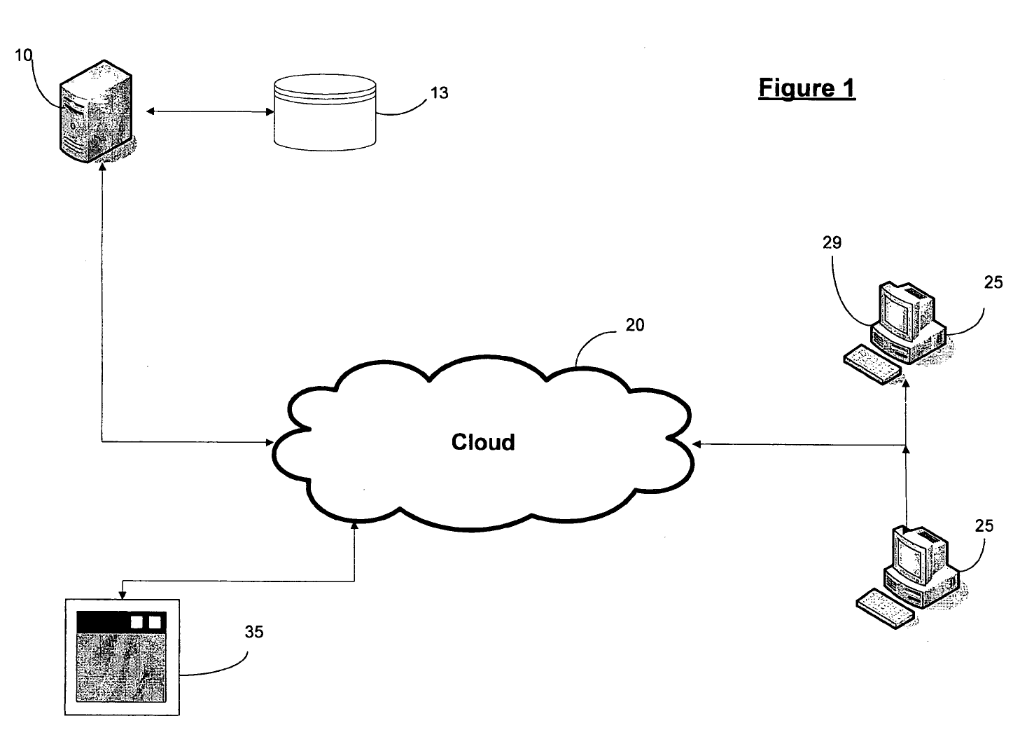

FIG. 1 is a diagram illustrating an exemplary system consistent with the concepts discussed herein. The system includes a server 10, a network 20, multiple user terminals 25, and an update service 35. Network 20 may be the Internet or any other computer network. User terminals 25 each include a computer readable medium 26, such as random access memory, coupled to a processor, and a user interface displayed on a display 29. User terminals 25, may also include a number of additional external or internal devices, such as, without limitation, a mouse, a CD-ROM, and a keyboard.

Server 10 communicates with user terminals 25 and update service 35 via network 20. Server 10 may include a processor coupled to a computer readable memory. Server 10 may additionally include one or more secondary storage devices 13, such as a database.

The server and user terminal processors can be any of a number of well known computer processors, such as processors from Intel Corporation of Santa Clara, Calif. In general, user terminal 25 may be any type of computing platform connected to a network and that interacts with application programs, such as a personal computer, personal digital assistant, or a smart cellular telephone. Server 10, although depicted as a single computer system, may be implemented as a network of computer processors, as is well known in the art.

In an implementation the computer readable memory of server 10 includes a content change tracking program, which pulls content from pre-identified sources on the Internet or other network in response to an update file received from an updating service 35. The content change tracking program or updating service 35 can include a web crawler or similar program for searching the Internet for content changes. Updating service 35 may communicate with server 10 via network 20 or may be integral to server 10.

An implementation of the content change tracking program includes an acquisition or harvesting function, an evaluation and content processing function, a categorization and indexing function, and a distribution function. The harvesting function pulls content from identified sources and normalizes the content for further categorization and analysis. The harvesting function may identify changes to preexisting content or identify new content found on the content source, such as a web page. The content evaluation and processing function evaluates the content from the acquisition program to determine, among other things, the source type, source reputation, content reputation, author, posting histories, and changes to the content as well as analysis of such changes to the content. The categorization and indexing function categorizes and indexes the content. The distribution function dispatches content and content statistics to a user.

A more detailed description of some of the functionalities implemented by the above-mentioned programs and functions is provided below.

Content Acquisition and Harvesting Function:

In an implementation content is harvested for evaluation of new or updated content. For example, content from a webpage may be pulled based off of a predetermined schedule or a notification event. A base text analysis is performed to catalog the content for future analysis. At some later time the content from the same source is pulled and analyzed to detect the textual differences between the content of the first pull and the content of the second pull. Any textual changes, either by addition or deletion are identified and cataloged for additional evaluation.

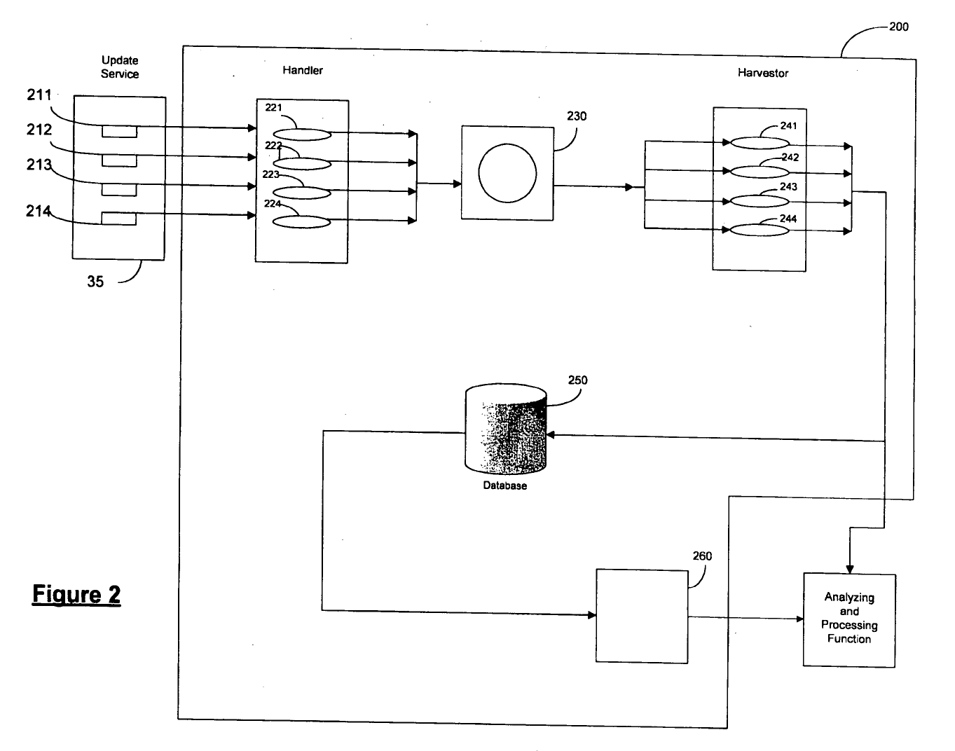

According to the implementation of FIG. 2, a content acquisition or harvesting function 200 may include multiple data sources 211-214, a number of feed handlers 221-224, a raw data message queue 230, multi-threaded harvesters 241-244, a data store 250, and a playback service 260.

The multiple data sources may form updating service 35 or may be integral to the acquisition program. The data sources 211-214 transmit notifications of new, updated or recently changed web content to the feed handlers 221-224 and may include, for example, a feed mesh consisting of one or more open or proprietary ping servers. Many blog authoring tools automatically send a signal or “ping” to one or more servers each time the blogger creates a new post (or updates/changes an old one). That is, the blog authoring tool sends an XML-RPC signal to one or more “ping servers,” which can then generate a list of blogs that have new material.

Open ping servers, like Verisign's Weblogs.com and Yahoo!'s blo.gs, let other web-services subscribe to a list of blogs that have recently pinged them. Blog search engines can provide fresh results very quickly by polling only the newly-updated blogs. Similarly, aggregators use results from ping servers to tell subscribers which items on their subscription lists have fresh material. A few of the blog aggregators that can be pinged directly include: BulkFeeds, FeedBurner, Google Blog Search, IceRocket, Technorati, Yahoo, and ZingFast.

The ping servers receive and collect XML-RPC signals, or pings, from other websites indicating that they have posted new content or updated existing content. After receiving a ping from one of these websites, a ping server may transmit a notification to a live feed handler 221, 222 in real time or close to real time (i.e., as a ping is received from a website), or it may store the notification and send it as part of a batch of notifications for transmission at a later time to a batch feed handler 223, 224. If the notification is transmitted in real time or close to real time, the ping server that sends the notification acts as a live data source 211, 212. On the other hand, if notifications are first collected and then transmitted at the same time, the ping server acts as a batch data source 213, 214.

Many different kinds of websites spanning a wide range of interests and categories may be monitored for new or updated content. For instance, these websites may include weblogs posted by an individual or a group of individuals, message boards, traditional news sites, interest group websites, company websites, or government sites. In addition, these websites may be part of a general list of publishers or content providers kept by the ping servers, or they may be a specific subset of websites that have been selected for monitoring. Because the Internet contains a vast amount of such publishers and content providers that may be posting new or updated content at any one point in time, in practice numerous data sources may be transmitting notifications to a large number of feed handlers 221-224, although only four data sources and four feed handlers are shown in the implementation of FIG. 2.

A notification from the update service 35 via data sources 211-214 that one or more websites of interest has new or updated content may be transmitted as part of an Extensible Markup Language (XML) file. The contents and format of the XML file may vary depending on the data source from which it originates or the website to which the notification relates. In some cases, only an XML snippet indicating where the new or updated content may be retrieved is transmitted to the feed handlers 221-224. An XML snippet may contain, for example, a Uniform Resource Identifier (URI) identifying the location of a Really Simple Syndication (RSS) feed of a website or, in some cases, only a link to the main page of the website itself or some other general page. Also in some cases, a small amount of information about the subject matter of the new or updated content may be included.

Although the foregoing examples and the following description describes implementations with respect to websites that syndicate their content with RSS feeds, it should be noted that the implementations are not limited to any particular web feed format. For example, websites with web feeds that conform to the Atom syndication specification, including those expressed in Web Ontology Language (OWL), also may be monitored for new or updated content. In addition, if a website does syndicate its content with an RSS feed, the implementations described are not limited to any particular RSS feed format (e.g., RSS 0.91, RSS 0.92, or RSS 2.0).

Returning to the implementation of FIG. 2, the feed handlers that receive the notifications from the data sources 211-214 may include live feed handlers 221, 222 for receiving notifications from the live data sources 211, 212 and batch feed handlers 223, 224 for receiving notifications from the batch data sources 213, 214. The notifications may be received as a result of being pushed by the data sources 211-214 to the feed handlers 221-224. In addition, the feed handlers 221-224 may pull the notifications from the data sources 211-214 at designated intervals of time or in response to a command.

As described above, a large number of notifications may be transmitted to the feed handlers at the same time by numerous data sources. In order to facilitate acquisition of the notifications in real-time or close to real-time, several feed handlers 221-224 are shown operating in parallel to receive different notifications. Also as described above, the notifications that are received by the feed handlers 221-224 may vary in content and format due to the potentially large number of data sources, many of which may be for example unrelated third party ping servers. As a result, the feed handlers 221-224 normalize the notifications to conform to a standard that is convenient for processing in later steps.

After the feed handlers 211-214 receive and normalize the notifications, the notifications are sent to the raw data message queue 230. The raw data message queue 230 may be, for example, a Java Message Service (JMS) server, also known as a message broker, acting as an intermediary that receives normalized notifications from the feed handlers 221-224 (the JMS producers) and dispatches the notifications to the harvesters 231-234 (the JMS clients). Since the feed handlers 211-214 may operate in parallel, a large number of notifications may be sent from the feed handlers 211-214 to the raw data message queue 230 at the same time. The raw data message queue 230 puts the notifications in a queue in the order in which they were received. Each notification in the queue then is sent by the raw data message queue 230 to only one of the harvesters 231-234.

Various commercial or open source Java Message Service (JMS) servers may be utilized to implement the raw data message queue 230. Since a notification that is put into the queue is sent to only one of the harvesters 241-244, the raw data message queue 230 should be able to operate according to a point-to-point messaging model. Examples of JMS servers that may be used include FioranoMQ, SonicMQ, ActiveMQ, MSMQ, and OpenJMS.

Using the information contained in the notifications, the harvesters 241-244 determine whether the notifications indeed identify websites that have posted new or updated/changed content and, if they have, retrieve the content from the websites. As described in greater detail below, depending on a number of factors, the harvesters 241-244 may need to perform a number of operations and the time that the harvesters 241-244 take to complete their operations may vary.

Harvesters 241-244 may be multi-threaded and operate in parallel so that each harvester receives a different notification from the raw data message queue 230. As with the data sources 211-214 and the feed handlers 221-214, although the implementation of FIG. 2 shows only four harvesters 241-244, in practice almost any number of harvesters may be used.

In a first step to determining whether a website has new or updated content, a harvester examines a notification for a URI indicating the location of the content or the website. If a URI is found, the harvester may screen the URI for undesirable websites or content. For example, the harvester may compare the URI against a predetermined list of websites that are to be avoided. Such undesirable websites may include those that are known to be producers of spam or websites with a specific generic top-level domain (gTLD) such as “.biz”.

If the URI does not indicate a location that is to be avoided, the harvester initiates a first harvest by pulling an RSS feed from that location. However, as discussed above, in some cases the URI may only indicate the location of a website's the main page or some other general webpage. If that is the case, the harvester also may perform a feed discovery function in which it searches for the website's RSS feed, which the harvester then pulls.

Next, the harvester indexes to the section of the RSS feed in which information about new or updated content may be found.

If the harvester determines that the website does indeed have new or updated content, the harvester may perform a secondary harvest by pulling the content from the website. The content may be normalized by the harvester if it does not conform to a standard that is convenient for processing by the system. After any such normalization, an XML object file may be created for compiling information relating to the content. In one implementation, the file may contain headings for the content's title, author, date of publication, date of last revision, main page, and subject matter. If the content already contains such information and may be extracted at this point, the proper headings are filled in. Other information that is not so readily available may be inserted in later steps, for example while the harvested data is in a natural language pipeline (NLP).

The harvesters 241-244 may either send the XML object files and the harvested content to the content analyzing and processing function, a data store 250, or both. The data store 250 is a storage system, for example a system of on- or off-site disk devices, used to store the XML object files and the harvested content. Such a storage system may be included as backup in case an error occurs in a later step and certain data needs to be reloaded. The data store 250 may alleviate the need to re-acquire the content from an outside website, which may cost both time and money. If for some reason the content needs to be processed by a harvester again, the data store 250 may retrieve the stored data and send it to the raw data message queue 230, which in turn dispatches the content to one of the harvesters 241-244. In addition, the backup of the content or XML file created for that content may be sent to a playback service 260. The playback service 260 then sends the data to the content analyzing and processing function of the content change tracking program.

Content Analysis and Processing Function:

An implementation of a method of processing the harvested content includes: queuing the harvested content for processing; converting the queued content for parallel processing; analyzing the content in one or more natural language processors including evaluating the quality of the changed content, queuing the analysis of the content with the harvested content, collating the analysis of the content with the harvested content to produce an analyzed harvested content file, and queuing the analyzed harvested content file for further handling, indexing, categorizing and display.

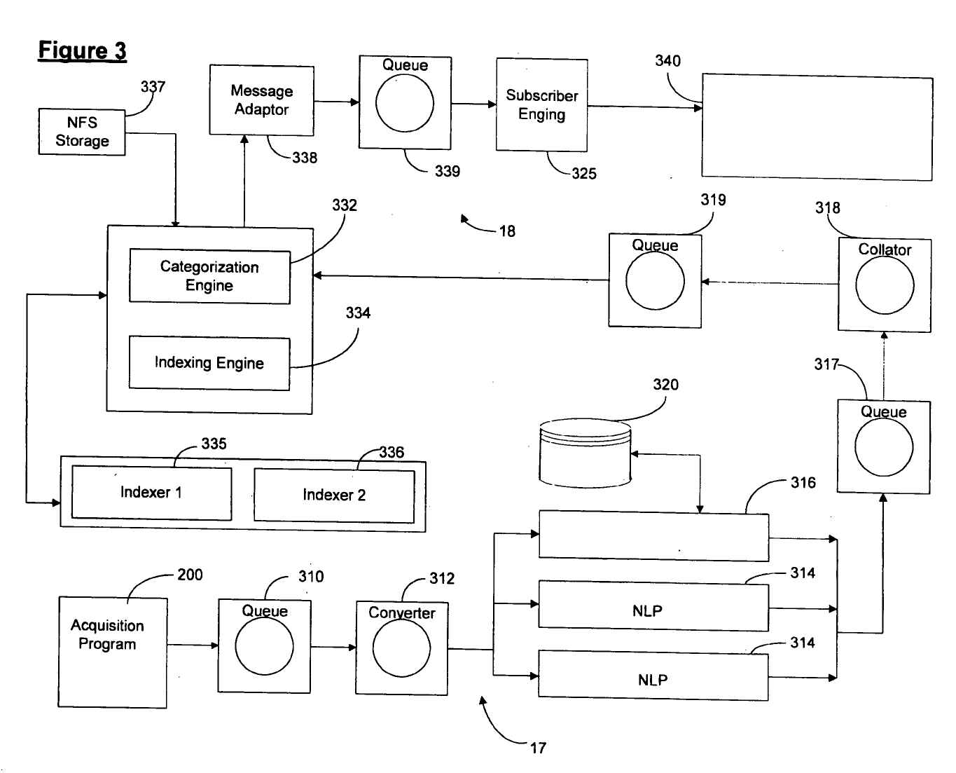

FIG. 3 depicts an implementation of a system for the content analyzing and processing function and may include a harvested data message queue 310, a queue-topic converter 312, one or more natural language processors 314, other content analysis processors 316, a natural language processor queue 317, a collator 318, and a collated data queue 319.

Like the raw data message queue 230 described above, the harvested data message queue 310, the natural language processor queue 317, and the collated data queue 319 may be, for example, a Java Message Service (JMS) server, or message broker. The harvested data message queue 310 may act as an intermediary that receives harvested data from the harvesters 241-244 (the JMS producers) and dispatches to a queue-topic converter 312 (the JMS client). The natural language processor queue 317 may act as an intermediary that receives processed data from the one or more natural language processors 314 (the JMS producers) and dispatches to the collator 318 (the JMS client). The collated data queue 319 may act as an intermediary that receives collated data from the collator 318 (the JMS producer) and dispatches to a JMS client.

The queue-topic converter 312, which operates according to a publisher/subscriber messaging model rather than a point-to-point model, may be included so that the same harvested data and associated XML file may be processed in parallel by multiple analytical programs in the one or more natural language processors 314 and other content analysis processors 316.

Examples of functions that may be performed by the one or more natural language processors include determining the implied sentiment of the content (i.e., is the content describing a topic of interest in a positive or negative light), extracting entities identified within text; automatic summarization activities; tracking mentions of entities (e.g. people or companies); linking entity mentions to database entries; uncovering relations between entities and actions; classifying text by reading/writing level or style; classifying text passages by language, character encoding, genre, topic, or sentiment; correcting spelling with respect to a text collection; clustering documents by implicit topic and discovering significant trends over time; providing part-of-speech tagging and phrase chunking; and determining the quality or relevance of changes, updates or deletions to content.

The other content analysis processors 316 may be analytical programs that are either within or independent from the one or more natural language processors 314. One example of functions that may be performed by the other content analysis processors 316 is analyzing the characteristics and quality of changes to content. Another example is determining the reputation of the source from which the content originated, which is a process that is well known in the art. For example, reputation scoring of webpage content is described in “Hilltop: A Search Engine Based on Expert Documents”; Krishna Bharat; February 2000, incorporated herein by reference.

One or more natural language processors 314 and the other content analysis processors 316 can also be connected to an external memory 320. External memory 320 can include a database of relevant keywords for use by the other content analysis processors 316 or the one or more natural language processors 314.

Because various analyses of the harvested data and associated XML file are performed in parallel, with results completed at different times depending on the harvested data content and the analytical process performed, collator 318 groups the results from the one or more natural language processors 314 and other content analysis processors 316 and re-associates the results with the harvested data and related XML object file. In general, processes for collating data from multiple data sources are well known in the art. Accordingly, further detail of the collating functionality will not be described herein.

Categorization and Indexing Function:

In order to provide current and updated information in real time or close to real time to an analyst or other user, newly posted information on a webpage is pulled from the source and processed to determine content attributes, as described above. Additionally, the content and content statistics may be evaluated for relevant information, categorized, indexed and displayed to a user.

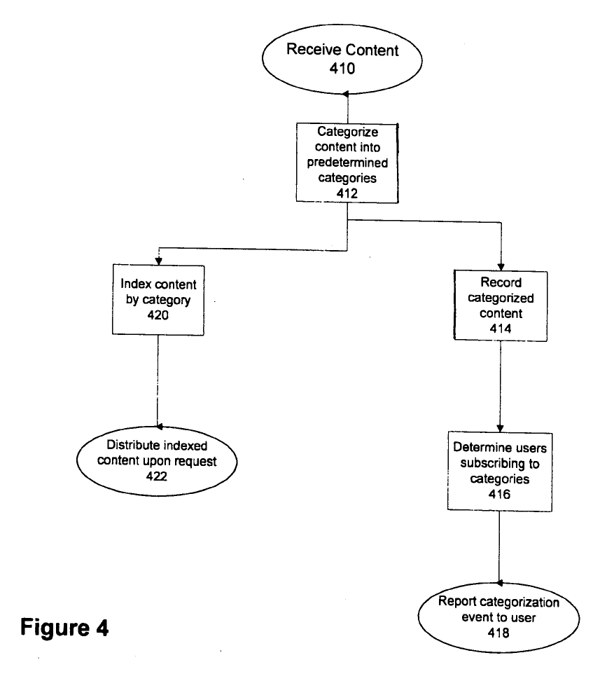

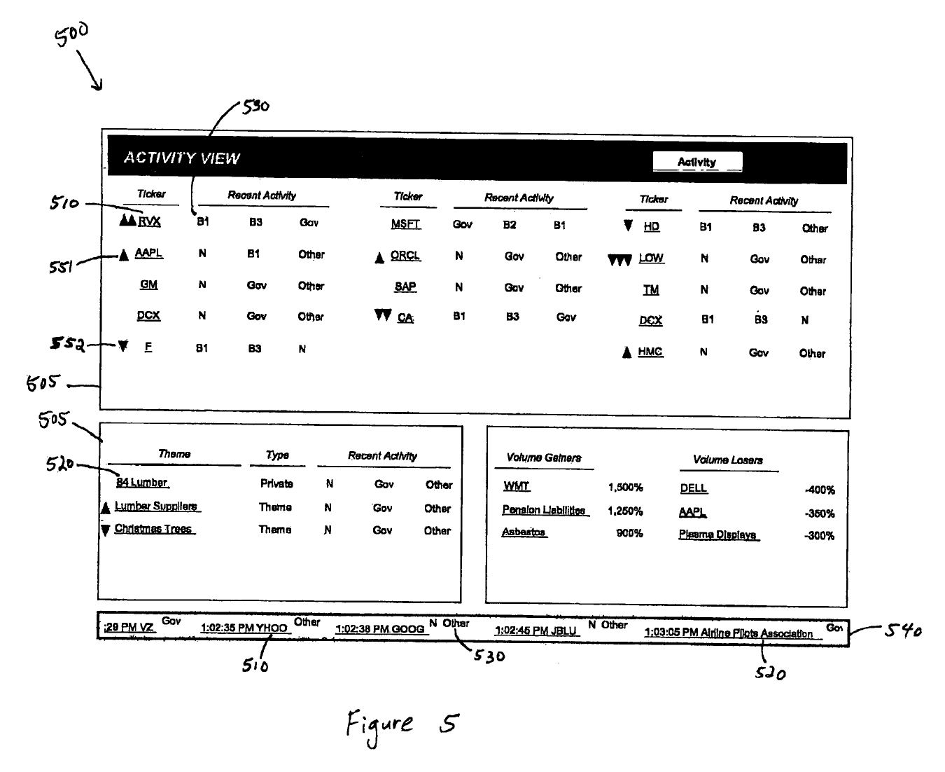

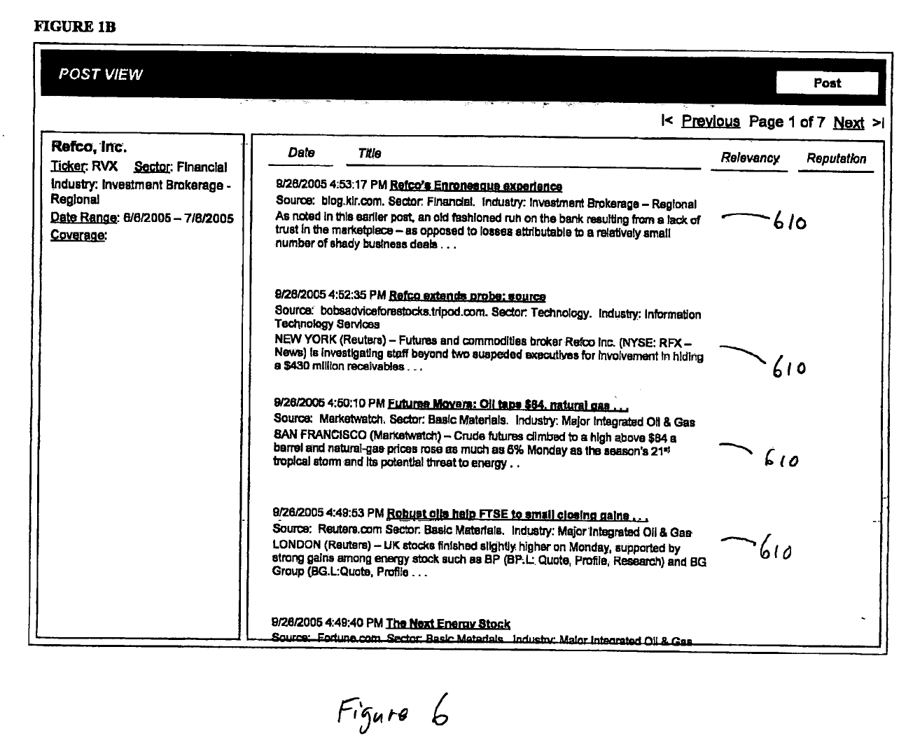

FIG. 4 depicts a flow chart of an implementation of a method of categorizing and indexing content comprising: receiving content and content statistics 410; categorizing the content and content statistics within one or more known categories thereby creating a categorization event 412; recording the categorization event 414; determining user profiles subscribing to content and content statistics associated with the one or more categories 416; notifying a user in real time or close to real time of the occurrence of a categorization event 418; indexing the content for storage and search 420; and sending the content and content statistics to a user based on a user profile via a search protocol 422.

Referring again to FIG. 3, a system is provided which includes a processing program 17 and an indexing program 18. Indexing program 18 many include a categorization engine 332, an indexing engine 334, a first indexer 335 and a second indexer 336, NFS storage 337, a message adaptor 338, a message queue 339, and a subscriber engine 325, which identifies user profiles subscribing to the one or more known categories, listens to categorization events occurring in categorization engine 332 and notifies a user or agent of the occurrence of a categorization event by pushing a notification and associated content statistics via a pushing engine 340. Categorizing engine 332 categorizes content into one or more predetermined categories for additional indexing by indexing engine 334. Categorization engine 332 notifies subscriber engine 325 of categorization events via category message adaptor 338 and queue 339.

Categorization and indexing functions are well known in the art. Indexing and categorization of content provides an information management utility optimized for search and classification of file system data, such as the harvested and processed content of the implementations described herein. During search and discovery processes, the index servers may create an abstract for each file by collecting file system metadata, extracting the file contents, and results from data processing associated with each file. These abstracts provide the foundation for consistent data classification and application of information governance policies, thereby preserving files for retention and controlling access based on user identification via a search interface.

Index and categorization engines 332 and 334 may be any known commercial or open-source indexing product and may reside within server 10 or on one or more dedicated servers connected to server 10 via a network. Examples of known categorization and indexing engines and servers include the Fast AIW from Fast, Inc. of Boston, Mass. and the Lucene Project.

However, known indexing services support the categorization and indexing of content. However, typically the user must pull this information from the data base. Analysts requiring real time or close to real time updates of content and content statistics associated with companies or themes of interest require a solution that pushes information to the user display upon notification of updated content. One such solution may be a system and method that actively listens for categorization events as they occur. The system and method matches the categorization event with agents or user profiles interested in the categorization event, and broadcasts such categorization events to the agent or user.

More specifically, in an implementation of the system depicted in FIG. 3, a subscriber engine 325 receives content and content statistics from a queue 319 and routes the content and content statistics to a categorization engine 332. As content is entered into the index 334 via categorization engine 332, the categorization engine categorizes a document and sends a notification to subscriber engine 325 via category message adaptor 338, and queue 339. Subscriber engine 325 actively listens for categorization events occurring in categorization engine 332. Subscriber engine 325 includes a publish/subscribe gateway that will notify agents or other external systems of a categorization event occurring in a specific category of interest, and a statistics engine that maintains various statistics about the categories such as total count by category and moving averages of counts by hour. Subscriber engine 325 includes a list of subscribers and the specific categories of interest to each subscriber. A JMS messaging system is used to transfer notification events from the categorization engine 332 to subscriber engine 325. Since most document indexing and categorization systems do not have messaging interfaces, a message adapter 338 receives categorization event notifications from the categorization engine 332, and writes events into a message queue 339. Subscriber engine 325 then reads the stream of category events from the queue and updated information is pushed to the appropriate user through pushing engine 340. In this manner subscribers (or users) may be notified of categorization events and analysis related to the categorization events in real time or close to real time through a user interface displayed on a display 29.

Furthermore, the indexing system may have two or more mirrored indexing subsystems so that it may handle a large number of indexing requests while at the same time having the newly indexed data available for querying. Referring to FIG. 3, a RAM subsystem 335 has an index that resides on a RAM disk and tuned for indexing units of data, and a physical subsystem 336 has an index that resides on a physical disk and is tuned for indexing batches of data. A RAM subsystem facilitates near instant indexing speeds (e.g., the time cost becomes the CPU time as opposed to CPU TIME+IO time) and near instant querying/retrieval post indexing. And use of the RAM subsystem also solves the issue of the index/query “lock” when the indexer has to rewrite the index. The physical subsystem resolves the issue of data loss. If the RAM subsystem fails, the physical subsystem has a physical version of the data that can be applied back to the RAM Subsystem. Further mirroring on the physical subsystem protects against the failure of a single physical subsystem.

In an implementation, content and related content statistics that have been identified, processed, categorized, and indexed can be pushed, using a push engine 340, to one or more end user terminals 25 operated by subscribers for display through a user interface on a display 29 to an end user. Delivery may be accomplished using push technologies such as streaming HTTP and Comet programming techniques. HTTP streaming is a mechanism for sending data from a Web server to a Web browser in response to an event. HTTP Streaming is achieved through several common mechanisms. In one such mechanism the web server does not terminate the response to the client after data has been served. This differs from the typical HTTP cycle in which the response is closed immediately following data transmission. The web server leaves the response open such that if an event is received, it can immediately be sent to the client. Otherwise the data would have to be queued until the client's next request is made to the web server. The act of repeatedly queing and re-requesting information is known as a polling mechanism. Typical uses for HTTP Streaming include market data distribution (stock tickers), live chat/messaging systems, online betting and gaming, sport results, monitoring consoles and Sensor network monitoring. Examples of push technology include Virgil's One, SmartClient, Lightstreamer, Pjax, and Pushlets.

User Interface

A significant component of a user's experience in operating a computer is the user interface, i.e., the manner in which the computer presents information to the user via a display device. In an effort to make the user experience as friendly and intuitive to the user as possible, graphical user interfaces are preferred. The graphical user interface may constitute an element of the computer's operating system, such as Windows® operating system provided by Microsoft Corporation of Redmond, Wash. In other cases the graphical user interface may comprise a separate application program that interacts with the operating system, or one that is integrated with the operating system.

In an implementation of a system and method of providing current and updated content and content statistics related to pre-identified WebPages and Internet sources associated with a common theme, such as relating to a company of interest, a graphical user interface is provided that is familiar to financial and business intelligence analysts. FIG. 1, discussed above, shows an example of the hardware components of a computer system in which the implementation of the user interface may be displayed on a display 29.

In one implementation, the user interface is part of a monitoring system for monitoring changes in Internet chatter. The user interface manipulates the appearance of a recognized symbol (e.g., a financial ticker symbol) and/or displays statistics about the changes in conjunction with the recognized symbol. Numerous statistics relating to just-posted Internet chatter pertaining to a category of information, such as an individual company, may be displayed in an interface contemplated herein. The just-posted content and related content statistics may be pulled in an acquisition program, processed by a processing program, and categorized and indexed, as previously described herein.

According to the exemplary implementation of FIG. 5, an interface display 500 is provided depicting various activity (e.g., chatter on the Internet or changes in content, meta data, and associated information relating to content changes) related to pre-identified topics of interest. The topics of interest can be specific companies, institutions, industry segments, academic subjects, government agencies, market sectors, financial products, general themes, or unassociated entities sharing a common theme.

In one implementation the topics of interest are identified on display 500 as specific tickers, which includes symbols 510 and themes 24, in a watchlist 505. The symbols 510, are financial symbols familiar to analysts and represent, for example, publicly traded companies, financial products or other securities. The themes 520 are pre-defined or user-customized general topics of interest, such as for example, “Lumber Suppliers.” In this example, information about Internet activity related to the symbols 510 and themes 520 are displayed in conjunction with the symbols 510 and themes 520. Such information can include changes in blog postings, news commentary, governmental or organizational reports, press releases, analyst recommendations, legal proceedings and court filings, changes to company Web pages, and the like. The information about Internet activity related to symbols 510 and themes 520 can be limited to a specific time frame (e.g., the preceding one to 60 minutes, the preceding one to 24 hours, the preceding one to seven days, the preceding week, the preceding month). The watchlist 505 comprises a collection of tickers or symbols 510 and themes 520 that are associated with a user, such as tickers of interest selected by the user. Watchlist 505 can be part of a subscription. Watchlist 505 can be based off a user profile and/or determined by a recommendation algorithm.

In one implementation display 500 provides visual notification to a user that changes in Internet activity associated with symbols 510 and themes 520 has occurred. In the implementation of FIG. 5, arrows 551, 552 in the shape of triangles pointing up or down are used as such visual notifications. Any character or symbol may be used as visual notification (e.g., plus or minus signs or differently shaped arrows). The number of symbols or characters that appear in conjunction with a symbol 510 or theme 520 differ according to various levels of changes in Internet activity related to the ticker, as explained in greater detail below.

In the implementation of FIG. 5, the user interface of display 500 notifies the user of increases or decreases in Internet activity related to a ticker based on standard deviations “σ” from a reference or normalized level such as a moving average over a period of time. The standard deviation σ is a quantity of change in activity that may be pre-defined or user-customized, and may be any number greater than zero. If the change in Internet activity related to a ticker from the reference level is less than σ, the change may be considered statistically insignificant and the symbol 510 or theme 520 is displayed in a manner indicating no change of significance has occurred, for example a display of symbol 510 or theme 520 as plain text standing alone. On the other hand, for increases in Internet activity that are greater than or equal to one standard deviation σ but less than two standard deviations 2σ, a single arrow 551 pointing upward is displayed in the vicinity of symbol 510. Similarly, for decreases that are greater than or equal to one standard deviation σ but less than 2σ, a single arrow 552 pointing downward is displayed in the vicinity of symbol 510. Furthermore, for increases and decreases greater than or equal to 2σ, two upward-pointing arrows 551 and two downward-pointing arrows 552 are displayed in the vicinity of symbol 510, respectively. Additional arrows may be displayed in a similar manner based on multiples of σ if notifications of greater levels of changes are desired.

In addition to using symbols or characters, the user interface of display 500 may also use other visual notifications such as colors to convey increases or decreases in Internet activity. In one implementation, the user interface displays symbols 510 or themes 520 in various color schemes to convey changes in the amount of activity related to a specific ticker, for example the characters comprising a specific ticker such as symbol 510 or theme 520 can be green to represent a specified increase from a reference activity volume, red to represent a decrease, and white to represent a change that is not statistically significant.

Thus, for example, if the change in Internet activity related to a symbol 510 over period of time has neither changed above or below a standard deviation σ compared to a reference level, then the user interface displays the ticker in white text. However, if the level of activity has increased by more than σ, the user interface displays the ticker in green text. Conversely, the ticker is displayed in red text if activity has decreased by more than σ. Greater increases or decreases in increments of a may then be indicated by combining color changes with other visual notifications, such as displaying one or more characters or symbols (e.g., arrows 551, 552) in the vicinity of the ticker as described above.

In further implementations, other textual formatting is used to indicate changes in Internet activity, for example a symbol 510 or theme 520 is displayed in plain text for little to no change in activity, bolded text for increased activity, and italicized text for decreases in Internet activity.

The interface of display 500 in the implementation of FIG. 5 also depicts source activity indicators 530 in conjunction with watchlist 505. The source activity indicators 530 notify the user, in real-time or close to real-time, of the source of new activity related to a ticker. The source of new activity can be blog postings, news wire feeds, news live reports, press releases, Web page postings, government agency reports or Web postings, non-governmental organization reports or Web postings, or court filings or legal proceedings. Source indicators 530 can be rated or prioritized, for example, prioritizing by reliability, quality, relevance, subscription level, viewing level, free or paid service, or by user defined criteria.

In the implementation of FIG. 5, one or more characters representing various sources are displayed to the right of a corresponding ticker: “N” is used to represent a news source such as a wire feed or an online newspaper; “B1” is used to represent blogs that are deemed by the system to be of the highest quality; “B2” is used to represent blogs that are considered to be a second tier of qualified blogs; “B3” is used to represent unqualified blogs with relevant text; “Gov” is used to represent government sites; and “other” is used to represent sources that do not fit within certain pre-defined categories of sources. If the new activity associated with a ticker includes postings from several such sources, more than one source activity indicator 530 can appear in the vicinity of the ticker.

In addition, the source activity indicators 530 can be manipulated to convey information about a particular source and/or to alert the user of recent activity. For example, upon detecting activity related to a ticker, that ticker and some or all of its potential data sources (e.g., the News, Government, or other activity indicators 530) can be outlined with a box for a period of time (e.g., one minute) in order to bring the new activity to the user's attention. In other implementations a ticker and associated activity indicators can flash repeatedly, appear in a larger font than other information on the page, or have a specialized character, icon or symbol displayed in conjunction with the ticker to alert the user of new activity. The alert function can be triggered by new activity from a pre-identified source, for example, the alert can be triggered by any Internet activity from the FDA associated with a symbol 510 or theme 520.

Other information that can be conveyed to the user includes the amount of time that has passed since new activity from a particular type of source was last detected. This is accomplished, for example, by displaying the source activity indicators 530 in a sequence starting from a blinking view, followed by a solid and fully illuminated view, followed by an increasingly faded view as more and more time passes after activity was last detected for that source category. More particularly, if a new news article corresponding to a ticker was detected within a defined period of time (e.g., within one hour), the “N” source activity indicator to the right of the ticker would blink. In this example, after an hour has passed since the article's detection and if no additional news article was detected in the interim, then the “N” source activity indicator would cease blinking and remain solid. Then, after some more time (e.g., twenty-four hours), the “N” source activity indicator would fade and eventually disappear entirely. After the indicator disappears, that particular data source is not used to calculate statistically significant changes in activity volume. It should be understood that the periods of time specified above can be altered or tailored by persons such as the user or a system administrator.

The implementation of FIG. 5 also depicts recent activity related to a ticker via a horizontally scrolling line of text 540 at the bottom of the activity page. The text includes tickers such as symbols 510 and themes 520 that may or may not be on a user's watchlist 13. As new activity related to a ticker is detected, the ticker is displayed in the line of text. Also scrolling along in the vicinity of the ticker may be additional information with respect to recently detected activity, such as the time that the activity was detected and the data source from which the activity originated. One or more data source indicators 530, representing recently detected data sources, are shown as superscripts to the tickers. In this way, information pertaining to change in activity related to the ticker can be efficiently summarized and conveyed to the user.

An additional feature of the user interface of display 500 can be the indication of the tickers with the largest increases and decreases in activity volume over a period of time. For example, in the lower right hand corner of the display 500 shown in FIG. 5, tickers having the largest increase and decrease in Internet activity are displayed along with their percentage of volume increases or decreases under the headings “Volume Gainers” and “Volume Losers.”

In the implementation of the user interface described herein, if the user desires more specific information related to one or more tickers, the user may switch to a “post” view from other views in the monitoring system. An example of a “post” view is shown as display 600 in FIG. 6. The post view in this example allows the user to view posts 610 which include previews of recently detected activity (e.g., a news article, a blog, or other postings) and other information such as the activity's title, time posted, source type, and/or categories under which the activity falls. The various posts 610 can also be sorted according to pre-defined or user-selected criteria, such as, for example, relevancy to a particular ticker, reputation of the source, and time of posting. In addition, all or part of each post can be a hyperlink to the actual source itself, such as the website hosting a new news article.

The user can switch to the post view in a variety of ways. For example, the user can select tabs in the user interface that toggle between various views, such as the “activity” view of display 500 and the “post” view of display 600. In the implementation of FIGS. 5 and 6, an “activity” tab and a “post” tab is provided near the upper right-hand corner of the currently displayed page. Furthermore, if the user is in the activity view, another way to switch to a post view for a particular ticker is to select the ticker itself, which may be a hyperlink to the ticker's posts 610.

Thus various implementations allow changes in Internet activity associated with a specific topic of interest to be categorized, summarized and displayed on a user interface and in a format that is familiar to financial services industry professionals. The analyst is able to view changes and trends in changes in Internet activity associated with a ticker symbol in real time or close to real time. And should a particular change in activity warrant closer examination, the analyst is able to view the specific source of the activity.

For a more detailed analysis of the changed activity, the analyst can view the source of the activity directly. Often the most interesting aspects of changes in Internet activity is the difference between the most recent Internet posting and the last available version or versions. But typically, the source of information does not highlight the changed information.

In another implementation, the analyst or financial services professional is provided an interface for viewing selected Internet sources and evaluating the changes to those sources over a period of time. The Internet sources can be identified from the interface of display 500 as described above.

Many Internet information sources incrementally change the content provided therein. For example, news services typically add updates to developing stories at the beginning of a news article, retaining the main body of the article with each posting. Many Internet information sources, such as news wires and blog postings, utilize RSS for content updates. RSS is particularly useful when new content is published in a log format, such as in a weblog or online journal. RSS, however, is less useful when only a portion of existing content is edited (e.g., as in the news article above.) Typically RSS feeds ignore revised content or treat revised content as newly published content, thereby redelivering the entire content. But redelivering the entire content provides no insight into what the content looked like before the update was published, what content has changed, and/or how much content has changed.

In an implementation a user interface is provided to efficiently display categorized content changes. The interface enables users, such as financial analysts, to more quickly and efficiently identify and assess the value and impact of content changes.

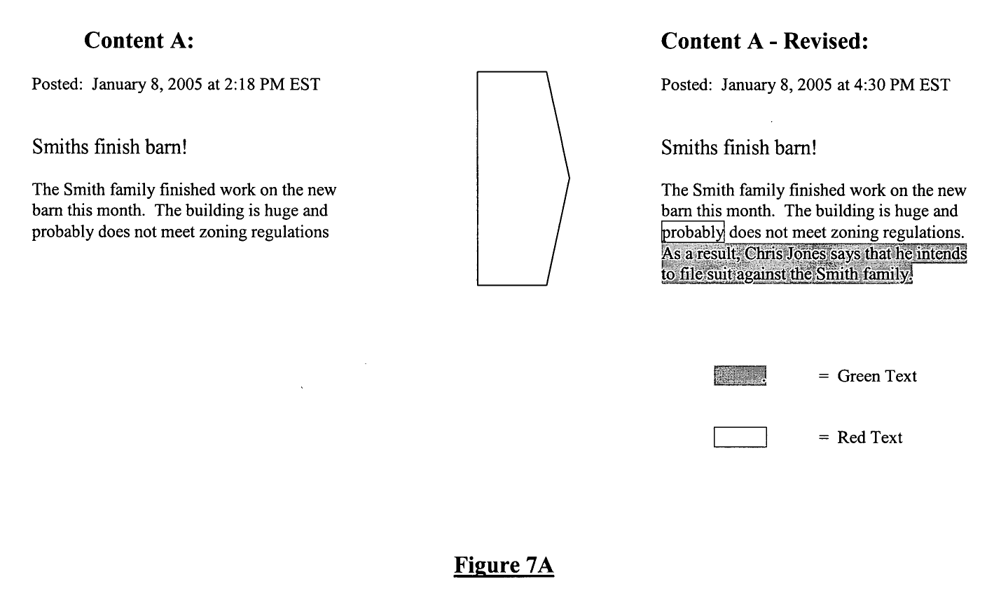

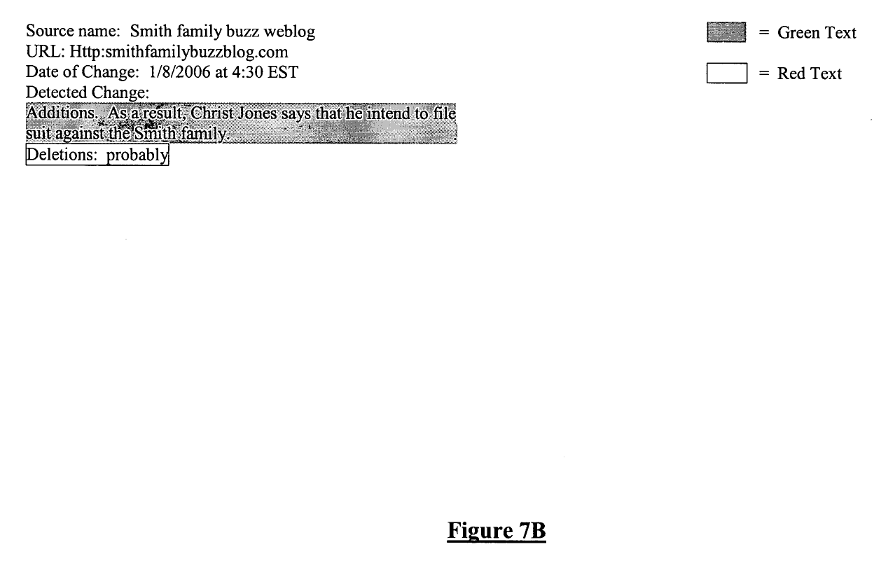

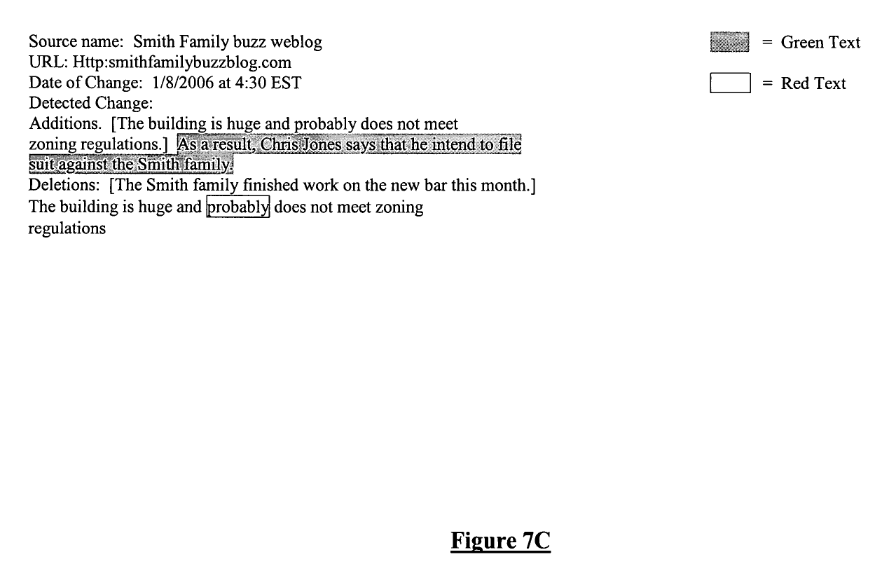

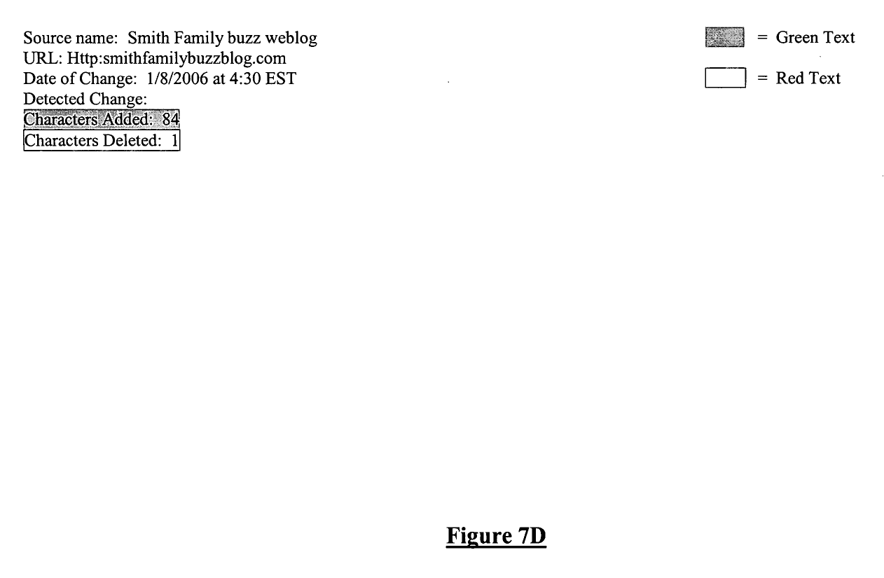

FIG. 7A depicts the detection and display of content change as it relates to the addition or deletion of content distributed by a typical RSS feed, for example, added text is contrasted from previous text and deleted text is dissimilarly contrasted from added text and previous text. As depicted in FIG. 7A, added text is displayed in one color, e.g., green and deleted text is displayed in a second color, e.g., red. Other contrasting displays or textual formatting are contemplated here in (e.g., bolded text, underscored text, contrasting fonts, contrasting character size, contrasting use of capital and lower case characters, flashing text, and/or symbols or icons associated with text).

Alerting the user to changed content provides numerous benefits, including: (1) increased efficiency by eliminating the need for a user to have to visually compare content and manually identify additions and/or deletions; (2) increased efficiency by allowing a user to search among detected changes by change type (addition, deletion, or both), the magnitude of the change (e.g., how many characters were changed), and assign a hierarchy for notifications via a feed, such as RSS according to user-specified criteria (e.g., type of change detected and/or threshold for the number of characters included in the change); reducing time needed to review changes, which can result in less costly review process as may be the case in legal review processes; (4) monitoring remote or distributed workforce productivity; (5) managing vast quantities of information and reducing information overload; (6) the capability to feed any content change data (e.g., words, number of characters, type of change); and (7) the capability to further linguistically analyze on the changed content.

FIG. 7B depicts an interface 701 displaying only the content change and content change data as it relates to the addition and/or deletion of distributed content. In this implementation, only the added and/or removed text is displayed, along with other key statistics such as a descriptive name for the source of the content, such as a web page name, the URL where the content change was detected, and the date and time that the change was detected. The changed or deleted contented can be displayed in any of the various contrasting methods discussed herein. As depicted in FIG. 7, the added text is displayed in green and the deleted text is displayed in red.

FIG. 7C depicts an interface 702 providing contextual references to added or deleted content. For example, in an implementation, one or more sentences preceding or following the changed text is provided as a contextual reference. As depicted in interface 702, the sentence preceding the changed content is included along with the added and/or removed text, accompanied by other key statistics such as a descriptive name for the Web page and/or its content, the URL where the content change was detected, and the date and time that the content change was detected.

FIG. 7D depicts yet another implementation wherein just the key statistics related to detected content change are displayed in an interface 704. The key statistics can include, the number of characters changed, the relevance of the changed content, whether any of the changed content includes any key words or phrases, whether any of changed content includes relevant links to other sources of content, as well as identifying information of the changed content source such as web page name, URL where the changed content was detected, time and date when the changed content was detected, and hours since the last detection.

The reader's attention is directed to all papers and documents which are filed concurrently with this specification and which are open to public inspection with this specification, and the contents of all such papers and documents are incorporated herein by reference.

All the features disclosed in this specification may be replaced by alternative features serving the same, equivalent or similar purpose, unless expressly stated otherwise. Although the present invention has been described in detail with reference to certain implementations, other implementations are possible. Therefore, the spirit and scope of the appended claims should not be limited to the description of implementations contained herein.

What is claimed:

1. A computer implemented method comprising:
receiving data representative of a change in volume of network content related to a ticker from a reference volume; and
displaying in a user interface a visual element associated with the ticker, wherein the appearance of the visual element depends upon the change in volume.

2. The method of claim 1 wherein the visual element comprises one or more characters representing the ticker.

3. The method of claim 2 wherein
the one or more characters is displayed having a first indication that the change in volume is less than a threshold volume;
the one or more characters is displayed having a second indication that the change in volume is an increase greater than or equal to the threshold volume; and
the one or more characters is displayed having a third indication that the change in volume is a decrease greater than or equal to the threshold volume.

4. The method of claim 3 wherein the visual element further comprises
a first symbol displayed in conjunction with the one or more characters if the change in volume is an increase greater than or equal to twice the threshold volume; and
a second symbol displayed in conjunction with the one or more characters if the change in volume is a decrease greater than or equal to twice the threshold volume.

5. The method of claim 5 wherein the visual element further comprises
an additional first symbol displayed in conjunction with the one or more characters if the change in volume is an increase greater than or equal to three times the threshold volume; and
an additional second symbol displayed in conjunction with the one or more characters if the change in volume is a decrease greater than or equal to three times the threshold volume.

6. The method of claim 2 wherein the visual element further comprises
a first symbol displayed in conjunction with the one or more characters if the change in volume is an increase greater than or equal to a threshold volume; and
a second symbol displayed conjunction with the one or more characters if the change in volume is a decrease greater than or equal to the threshold volume.

7. The method of claim 7 wherein the visual element further comprises
an additional first symbol displayed in conjunction with the one or more characters if the change in volume is an increase greater than or equal to two times the threshold volume; and
an additional second symbol displayed in conjunction with the one or more characters if the change in volume is a decrease greater than or equal to two times the threshold volume.

8. The method of claim 2 further comprising
displaying an indicator in conjunction with the visual element to indicate a source of network content, the source being attributed to the to at least a portion of the change in volume.

9. The method of claim 8 further comprising
distinguishing the visual element and the indicator from other aspects of the user interface if the network content attributed to the change in volume is detected within a predefined period of time.

10. The method of claim 8 wherein the visual element and indicator is distinguished from other aspects of the user interface.

11. The method of claim 8 wherein the indicator is adapted to change in appearance as time passes from when the network content attributed to the change in volume was first detected.

12. The method of claim 11 wherein the change in appearance includes the indicator blinking intermittently.

13. The method of claim 12 wherein the change in appearance includes the indicator gradually fading away as time passes.

14. The method of claim 12 wherein the indicator disappears after a period of time passes from when the network content attributed to the change in volume was first detected.

15. An apparatus comprising:
a processor;
a display screen coupled to the processor; and
memory coupled to the processor, wherein
the memory includes logic that has access to data representative of a change in volume of network content related to a ticker from a reference volume and operable to display in a user interface on the display screen a visual element associated with the ticker, wherein the appearance of the visual element depends upon the change in volume.

16. The apparatus of claim 15 wherein the visual element comprises one or more characters representing the ticker.

17. The apparatus of claim 16 wherein
the logic is further operable to display in the user interface the one or more characters having a first indication that the change in volume is less than a threshold volume;
the logic is further operable to display in the user interface the one or more characters in a second indication that the change in volume is an increase greater than or equal to the threshold volume; and
the logic is further operable to display in the user interface the one or more characters in a third indication that the change in volume is an increase greater than or equal to the threshold volume.

18. The apparatus of claim 16 wherein
the logic is further operable to display in the user interface a first symbol in conjunction with the of the one or more characters if the change in volume is an increase greater than or equal to twice the threshold volume; and
the logic is further operable to display in the user interface a second symbol in conjunction with the one or more characters if the change in volume is a decrease greater than or equal to twice the threshold volume.

19. The apparatus of claim 16 wherein
the logic is further operable to display in the user interface a first symbol in conjunction with the one or more characters if the change in volume is an increase greater than or equal to a threshold volume; and
the logic is further operable to display in the user interface a second symbol in conjunction with the one or more characters if the change in volume is a decrease greater than or equal to the threshold volume.

20. The apparatus of claim 16 wherein the logic is further operable to display an indicator in conjunction with the visual element to indicate a source of network content attributed to the change in volume.

21. The apparatus of claim 20 wherein the logic is further operable to distinguish the visual element and the indicator from other aspects of the user interface if network content attributed to the change in volume is detected within a predefined period of time.

22. The apparatus of claim 20 wherein the logic is further operable to change the appearance of the indicator in the user interface as time passes from when the network content attributed to the change in volume was first detected.

23. The apparatus of claim 22 wherein the logic is further operable to remove the indicator from the user interface after a predetermined period of time passes from when the network content attributed to the change in volume was first detected.
